(19) United States
(12) Patent Application Publication
(10) Pub. No.: US 2024/0010141 A1
(43) Pub. Date: Jan. 11, 2024

(54) VEHICLE WITH A ZONE ARCHITECTURE

(71) Applicant: Robert Bosch GmbH, Stuttgart (DE)

(72) Inventors: Jochen Pflueger, Muehlacker (DE); Manuel Warwel, Tamm (DE); Richard Schoettle, Oelbronn (DE); Viola Malena Herbrig, Ludwigsburg (DE); Achim Henkel, Stuttgart (DE); Alexander Fuchs, Fellbach (DE)

(21) Appl. No.: 18/253,003

(22) PCT Filed: Dec. 6, 2021
(86) PCT No.: PCT/EP2021/084348

§ 371 Date: May 15, 2023

(30) Foreign Application Priority Data
Dec. 9, 2020 (DE) 10 2020 215 525.9

(51) Int. Cl. B60R 16/03; B60R 16/023

(52) U.S. Cl. CPC B60R 16/03; B60R 16/023

(57) ABSTRACT

A vehicle. The vehicle has a front region zone, a right-hand cabin zone, a left-hand cabin zone, and a rear region zone. Each zone has a defined number of zone controllers.

### FIELD

The present invention relates to a vehicle comprising a zone architecture.

### BACKGROUND INFORMATION

E/E architectures with networking based on vehicle domains, i.e. separate, mostly star-shaped communication networks and tree-shaped vehicle electrical power system structures for each domain (chassis, drive, vehicle body (interior or exterior)), are the state of the art. The drawback is the complex cabling or the complex wiring harness.

### SUMMARY

The present invention relates to a new architectural concept for networking components installed in a vehicle. According to an example embodiment of the present invention, the zones front region, right-hand cabin, left-hand cabin and rear region are advantageously differentiated, and each zone comprises a defined number of zone controllers.

Advantageously, according to an example embodiment of the present invention, separate zone controllers are implemented in the cabin and the rear for safety-related consumers.

If the consumers for implementing vehicle functions are to be supplied via a QM network, separate zone controllers are installed for this purpose. Safety-related ASIL consumers are thus safely separated from one another via a safety-related vehicle electrical power system and QM consumers are separated from one another via a QM network and complexity is reduced by the zone architectures.

A power source configured as a DC/DC converter is disposed in the front zone. However, it is also possible for the power source to be configured as another embodiment that appears useful to the person skilled in the art.

An electrical power distributor, which supplies electrical power to the right-hand cabin, left-hand cabin and rear region zones, is advantageously disposed in the front zone. This advantageously makes it possible to ensure a reliable power supply to the zones.

According to an example embodiment of the present invention, the front zone advantageously comprises a separating element, which is configured as a vehicle electrical system switch. According to the present invention, the separating element can disconnect the safety-related vehicle electrical power system from the QM network. This makes it possible to easily implement a reliable vehicle electrical power system.

By providing two separate busbars within the zones, there is no need for further measures for implementing the freedom from interference between QM consumers and safety-related ASIL consumers. It is thus possible to implement a cost-efficient architecture.

Further advantages and expedient embodiments can be found in the description of the FIGURE and the FIGURE.

### BRIEF DESCRIPTION OF THE DRAWINGS

FIG. 1 shows a vehicle comprising a zone architecture according to an example embodiment of the present invention.

### DETAILED DESCRIPTION OF EXAMPLE EMBODIMENTS

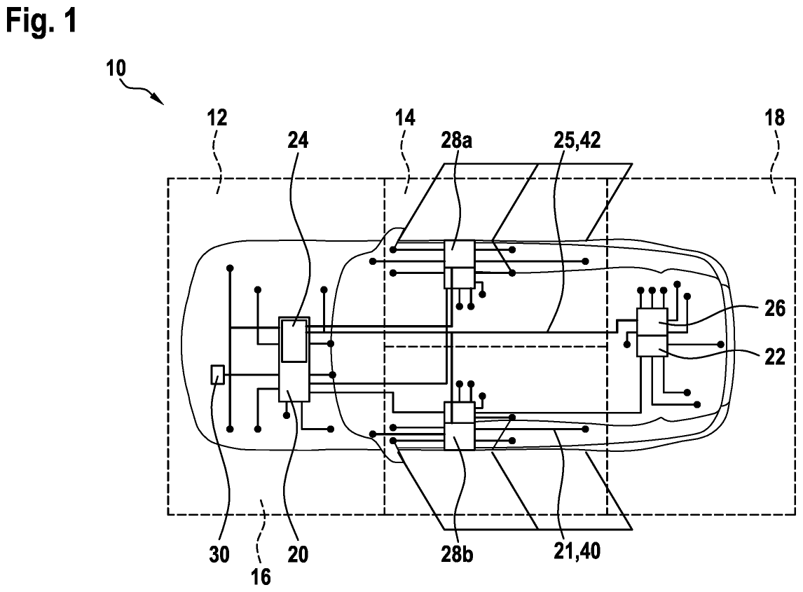

FIG. 1 shows a simplified illustration of a vehicle 10 comprising four defined zones. The following zones can be seen:
Front region zone 12
Right-hand cabin zone 14
Left-hand cabin zone 16
Rear region zone 18

The FIGURE also shows a number of zone controllers.

Consumers 20, 22 for implementing vehicle functions are disposed in the front zone 12 and the rear region zone 18. The consumers for implementing vehicle functions 20, 22 are connected to one another via a QM network 21.

Safety-related ASIL consumers 24, 26, 28a and 28b are connected to one another via a safety-related vehicle electrical power system 25.

In the embodiment according to the present invention, a power source 30 is disposed in the front zone. The power source 30 is a DC/DC converter. Any other power source that appears useful to the person skilled in the art is possible too, however.

It is also possible for the power source 30 to be disposed in a different zone and not in the front region zone 12.

The front zone further comprises a separating element. The separating element is configured as a vehicle electrical system switch.

The separating element can disconnect the safety-related vehicle electrical power system from the QM network. The front zone thus forms a so-called safety island.

However, it is also possible for another zone to be configured as a “safety island” and for the separating element to accordingly be disposed in a different zone ECU.

In an alternative embodiment of the present invention, the vehicle electrical system disconnecting switch can also be implemented as an external component that is not integrated into a zone ECU.

The other zones are supplied from the front zone via at least two channels 40, 42. Both the consumers for implementing vehicle functions 20, 22 and the safety-related ASIL consumers 24, 26, 28a and 28b are supplied.

The subordinate right-hand cabin zone 14, left-hand cabin zone 16 and rear region zone 18 are configured as combined distribution star points.

The power supply cables of the safety-related ASIL consumers 24, 26, 28a and 28b have to be pulled only to these star points.

The isolation between the QM network 21 and the safety-related vehicle electrical power system 25 takes place within the front zone 12. It is thus possible to provide two separate busbars within the zones. Further measures for implementing the freedom from interference between the consumers for implementing vehicle functions 20, 22 and the safety-related ASIL consumers 24, 26, 28a and 28b can be omitted.

The safety-critical network includes another energy store, which is configured to ensure the availability of electrical energy even in the event of failure of the primary power source. The energy store can be configured as a double layer capacitor, as flywheel energy storage or the like.

1-8. (canceled)

9. A vehicle, comprising:
a front region zone;
a right-hand cabin zone;
a left-hand cabin zone; and
a rear region zone;
wherein each of the zones includes a defined number of zone controllers.

10. The vehicle according to claim 9, wherein the front region zone and the rear region zone include consumers for implementing vehicle functions.

11. The vehicle according to claim 10, wherein consumers for implementing vehicle functions are connected to one another via a QM network.

12. The vehicle according to claim 10, wherein safety-related ASIL consumers are connected to one another via a safety-related vehicle electrical power system.

13. The vehicle according to claim 9, wherein a power source is disposed in the front region zone, wherein the power source is configured as a DC/DC converter.

14. The vehicle according to claim 9, wherein the zones are supplied from the front region zone via at least two channels.

15. The vehicle according to claim 12, wherein the consumers for implementing vehicle functions and the safety-related ASIL consumers are supplied via the zones.

16. The vehicle according to claim 9, wherein the right-hand cabin zone, the left-hand cabin zone, and rear region zone are configured as combined distribution star points of a power supply.
